(19) United States
(12) Patent Application Publication
(10) Pub. No.: US 2015/0194139 A1
(43) Pub. Date: Jul. 9, 2015

(54) Musical Instrument Stand that is Folded Easily

(71) Applicant: Tsung-Yao Yu, Taichung City (TW)

(72) Inventor: Tsung-Yao Yu, Taichung City (TW)

(21) Appl. No.: 14/148,855

(22) Filed: Jan. 7, 2014

(51) Int. Cl. G10G 5/00

(52) U.S. Cl. CPC G10G 5/00

(57) ABSTRACT

A musical instrument stand includes a base, two support units, and a backrest unit. The support units are pivotally mounted on two opposite sides of the base. Each of the support units includes a holding portion mounted the top of the base. The backrest unit includes an extension arm disposed between the support units and having a first end pivotally connected with the base, and at least one resting portion mounted on a second end of the extension arm. The backrest unit is movable relative to the base between an expanded position where the resting portion of the backrest unit is far away from the base, and a folded position where the resting portion of the backrest unit is adjacent to the base.

### BACKGROUND OF THE INVENTION

1. Field of the Invention

The present invention relates to a stand and, more particularly, to a musical instrument stand.

2. Description of the Related Art

A conventional musical instrument stand comprises a support frame to place a musical instrument in a three-point support manner. However, the bottom of the support frame occupies a large space when the support frame is fully expanded, so that when a person touches or hits the musical instrument stand unintentionally, the musical instrument stand together with the musical instrument easily falls to the ground. In addition, the conventional musical instrument stand is used to place the musical instrument with a fixed size and cannot be adapted to place another musical instrument of different kind and size, so that it is necessary to provide multiple musical instrument stands for placing musical instruments of different kinds and sizes, thereby increasing the costs and wasting the space of storage.

### BRIEF SUMMARY OF THE INVENTION

The present invention is to provide a musical instrument stand that is folded easily.

In accordance with the present invention, there is provided a musical instrument stand comprising a base, two support units mounted on the base, and a backrest unit mounted on the base. The support units are pivotally mounted on two opposite sides of the base. Each of the support units includes a holding portion mounted a top of the base. The backrest unit includes an extension arm having a first end pivotally connected with the base, and at least one resting portion mounted on a second end of the extension arm. The extension arm of the backrest unit is located at a rear portion of the base and is disposed between the support units. The backrest unit is movable relative to the base between an expanded position where the resting portion of the backrest unit is far away from the base, and a folded position where the resting portion of the backrest unit is adjacent to the base.

The base contains a recess. The backrest unit and the support units are respectively arranged on a periphery of the recess of the base. The base is provided with a plurality of limit projections arranged in the recess. The support units are movable relative to the base between an opened position where the support units are far away from the limit projections of the base, and a closed position where the support units are adjacent to the limit projections of the base. The base has a front portion provided with a snap-fit portion. The extension arm of the backrest unit mates with the snap-fit portion of the base in a concave-convex complimentary manner. Thus, the extension arm of the backrest unit is fixed and limited by the snap-fit portion of the base when the backrest unit is disposed at the folded position. The musical instrument stand further comprises two supporting bars mounted on the base. Each of the supporting bars is pivotally mounted on a bottom of the rear portion of the base and is extended in a direction that is far away from the base. Each of the supporting bars is pivotable upward and downward relative to the base. The holding portion of each of the support units is gradually inclined downward from a front portion of the base toward the rear portion of the base. Each of the support units further includes a front stop mounted on the base, and a rear stop mounted on the base. Each of the support units further includes an auxiliary stop pivotally mounted on the base. The auxiliary stop of each of the support units is disposed between the front stop and the rear stop. The extension arm of the backrest unit is inclined toward a direction that is far away from the base, when the backrest unit is disposed at the expanded position.

According to the primary advantage of the present invention, the musical instrument is limited by the support units and the backrest unit so that the musical instrument stand can support the musical instrument exactly.

According to another advantage of the present invention, the supporting bars protrudes outward from the base to support the musical instrument so that the musical instrument stand can support the musical instrument solidly and stably.

According to a further advantage of the present invention, the musical instrument stand can be folded easily and quickly to have a shortened volume when not in use, thereby facilitating packaging, storage and transportation of the musical instrument stand.

According to a further advantage of the present invention, the support units and the backrest unit co-operate to clamp and support musical instruments of different kinds and sizes, thereby increasing the versatility of the musical instrument stand.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a musical instrument stand in accordance with the preferred embodiment of the present invention.

FIG. 2 is a top view of the musical instrument stand as shown in FIG. 1.

FIG. 3 is a front view of the musical instrument stand as shown in FIG. 1, wherein the support units are disposed at the opened position, and the backrest unit is disposed at the expanded position.

FIG. 4 is a schematic operational view of the musical instrument stand as shown in FIG. 3, wherein the support units are disposed at the closed position, and the backrest unit is disposed at the expanded position.

FIG. 5 is a folded view of the musical instrument stand as shown in FIG. 4, wherein the support units are disposed at the closed position, and the backrest unit is disposed at the folded position.

FIG. 6 is a side operational view of the musical instrument stand as shown in FIG. 1.

FIG. 7 is a perspective operational view of the musical instrument stand for a musical instrument with a smaller size.

### DETAILED DESCRIPTION OF THE INVENTION

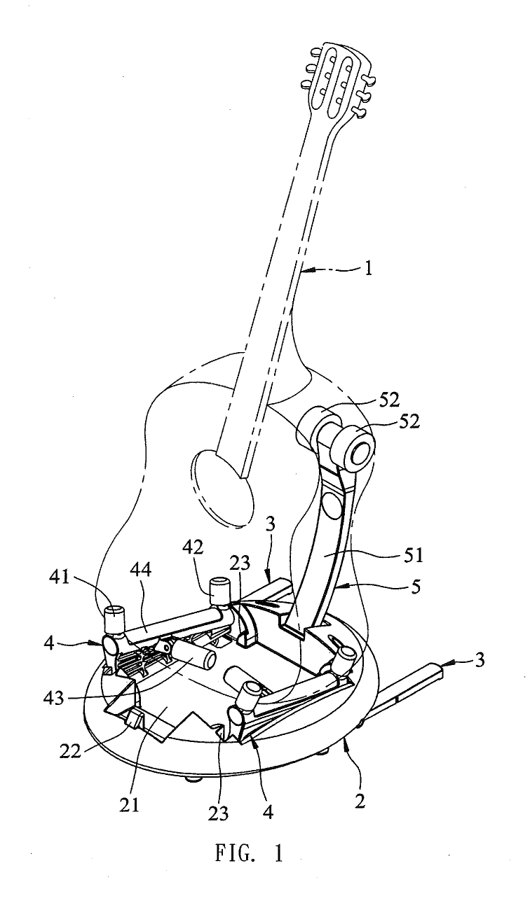

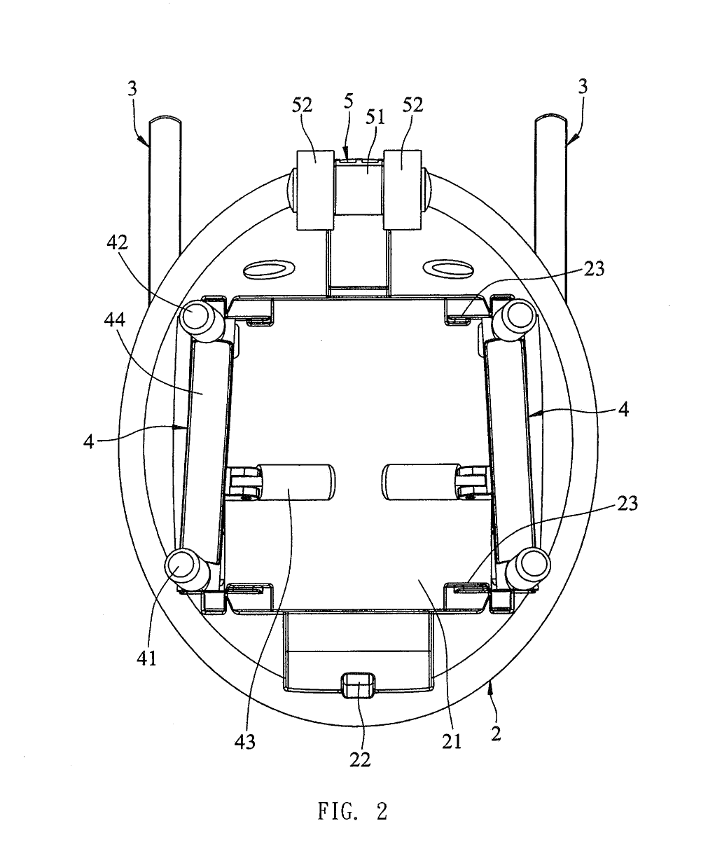

Referring to the drawings and initially to FIGS. 1-5, a musical instrument stand in accordance with the preferred embodiment of the present invention is used for placing a musical instrument 1 (such as a guitar, violin and the like), and comprises a base 2, two support units 4 mounted on the base 2, a backrest unit 5 mounted on the base 2, and two supporting bars 3 mounted on the base 2.

The base 2 contains a recess 21 which has a substantially rectangular shape. The base 2 is provided with a plurality of limit projections 23 arranged in the recess 21. Preferably, the base 2 is provided with four limit projections 23 which are arranged on four corners of the recess 21. The limit projections 23 of the base 2 are spaced from each other. The base 2 has a front portion provided with a snap-fit portion 22.

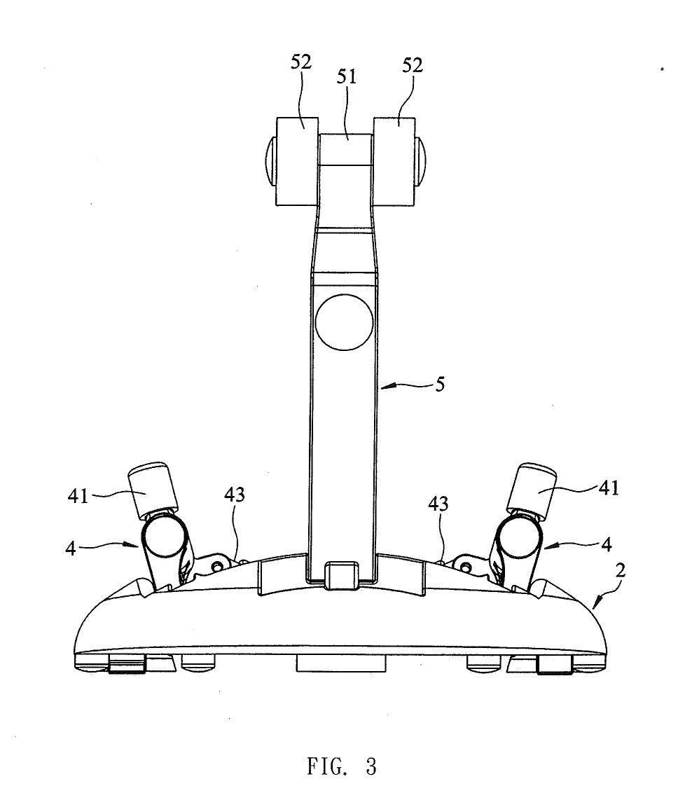

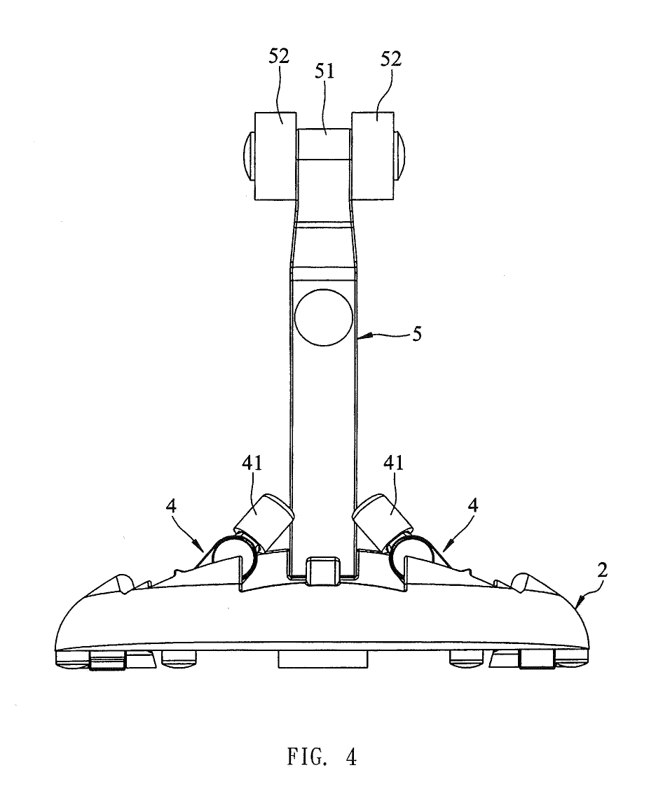

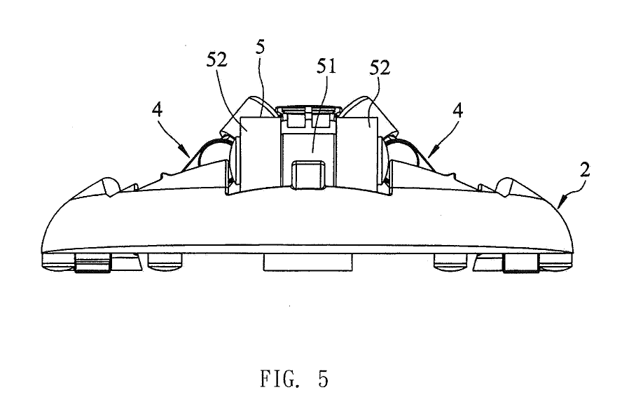

The support units 4 are disposed in the recess 21 of the base 2, and are pivotally mounted on two opposite sides of the base 2 in a symmetric manner. Preferably, the support units 4 are located between the limit projections 23 of the base 2. The support units 4 are movable relative to the base 2 between an opened position as shown in FIG. 3 where the support units 4 are far away from the limit projections 23 of the base 2 and abut the recess 21 of the base 2, and a closed position as shown in FIG. 4 or 5 where the support units 4 are adjacent to and limited by the limit projections 23 of the base 2.

Each of the support units 4 includes a holding portion 44 mounted a top of the base 2, a front stop 41 mounted on the base 2, a rear stop 42 mounted on the base 2, and an auxiliary stop 43 pivotally mounted on the base 2. The front stop 41 of each of the support units 4 is located at the front portion of the base 2. The rear stop 42 of each of the support units 4 is located at the rear portion of the base 2. The holding portion 44 of each of the support units 4 is disposed between the front stop 41 and the rear stop 42 and is gradually inclined downward from the front portion of the base 2 toward the rear portion of the base 2. The auxiliary stop 43 of each of the support units 4 is disposed between the front stop 41 and the rear stop 42. In the preferred embodiment of the present invention, the holding portion 44 of each of the support units 4 is made of material with a buffering effect, such as Styrofoam, sponge, rubber, plastics, leather and the like.

The backrest unit 5 and the support units 4 are respectively arranged on a periphery of the recess 21 of the base 2. The backrest unit 5 is adjacent to the recess 21 of the base 2 and includes an extension arm 51 having a first end pivotally connected with the base 2, and at least one resting portion 52 mounted on a second end of the extension arm 51.

The backrest unit 5 is movable relative to the base 2 between an expanded position as shown in FIG. 3 or 4 where the resting portion 52 of the backrest unit 5 is far away from the base 2, and a folded position as shown in FIG. 5 where the resting portion 52 of the backrest unit 5 is adjacent to the base 2.

In the preferred embodiment of the present invention, the resting portion 52 of backrest unit 5 is made of material with a buffering effect, such as Styrofoam, sponge, rubber, plastics, leather and the like. The backrest unit 5 preferably includes two resting portions 52 mounted on two opposite sides of the second end of the extension arm 51.

The extension arm 51 of the backrest unit 5 is located at the rear portion of the base 2 and is disposed between the support units 4. The extension arm 51 of the backrest unit 5 mates with the snap-fit portion 22 of the base 2 in a concave-convex complimentary manner. Thus, the extension arm 51 of the backrest unit 5 is fixed and limited by the snap-fit portion 22 of the base 2 when the backrest unit 5 is disposed at the folded position. The extension arm 51 of the backrest unit 5 is inclined toward a direction that is far away from the base 2, when the backrest unit 5 is disposed at the expanded position.

The supporting bars 3 are arranged symmetrically and are spaced from each other. Each of the supporting bars 3 is pivotally mounted on a bottom of the rear portion of the base 2 and is extended in a direction that is far away from the base 2. In the preferred embodiment of the present invention, each of the supporting bars 3 is pivotable upward and downward relative to the base 2. Alternatively, each of the supporting bars 3 is pivotable rightward and leftward relative to the base 2.

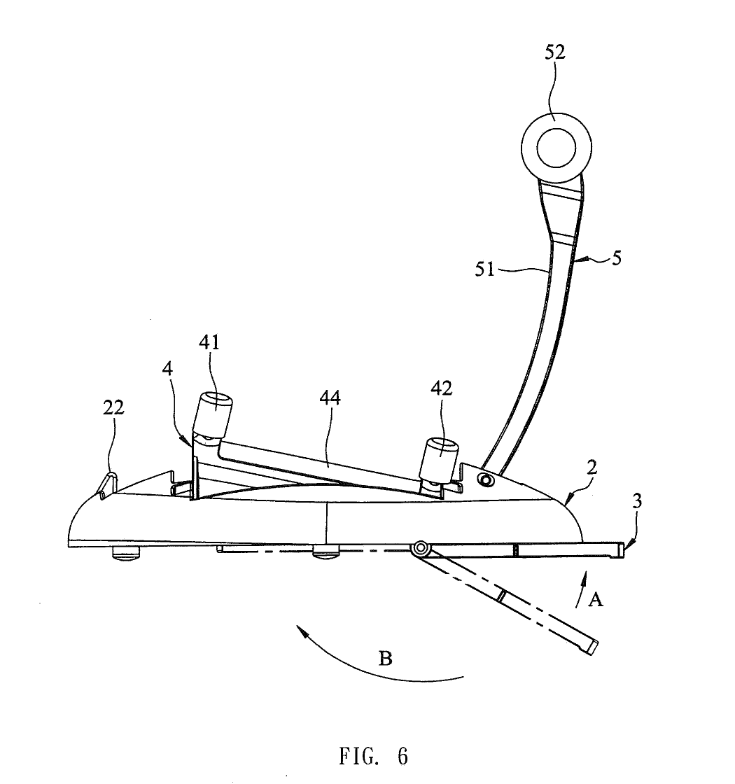

In operation, referring to FIGS. 1-6, the support units 4 are pivoted relative to the base 2 to the opened position as shown in FIG. 3, and the backrest unit 5 is pivoted relative to the base 2 to the expanded position as shown in FIG. 3. Then, the large-scale musical instrument 1 (such as a guitar, viola and the like) is placed between the support units 4 and the backrest unit 5 as shown in FIG. 1. In such a manner, the musical instrument 1 is supported by the holding portion 44 of each of the support units 4 and the resting portion 52 of the backrest unit 5. At this time, each of the supporting bars 3 is pivoted relative to the base 2 in the direction indicated by the arrow “A” as shown in FIG. 6. In such a manner, each of the supporting bars 3 is directed rearward and extended in a direction that is far away from the base 2 so that each of the supporting bars 3 protrudes outward from the base 2 to support the musical instrument 1 solidly and stably.

As shown in FIG. 4, the support units 4 are pivoted relative to the base 2 to the closed position to clamp a musical instrument (such as a saxophone) with a smaller size. In such a manner, the musical instrument is supported by the holding portion 44 of each of the support units 4 and the resting portion 52 of the backrest unit 5.

As shown in FIG. 5, when the musical instrument stand is not in use, the support units 4 are pivoted relative to the base 2 to the closed position, the backrest unit 5 is pivoted relative to the base 2 to the folded position, and each of the supporting bars 3 is pivoted relative to the base 2 in the direction indicated by the arrow “B” as shown in FIG. 6 to reach a retracted position. In such a manner, the musical instrument stand is folded not in use to have a shortened volume, thereby facilitating packaging, storage and transportation of the musical instrument stand.

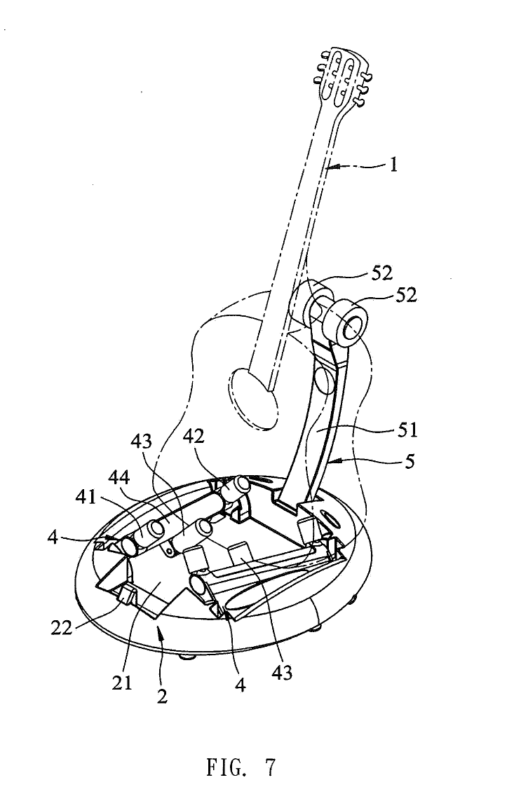

As shown in FIG. 7, when the musical instrument stand is used to support a musical instrument 1 (such as a ukulele or violin) with smaller width and thickness, the support units 4 are pivoted relative to the base 2 to the closed position, and the auxiliary stop 43 of each of the support units 4 is pivoted upward to protrude from the holding portion 44, so that the musical instrument 1 is clamped between the auxiliary stop 43 and of each of the support units 4. Accordingly, the musical instrument 1 is limited by the support units 4 and the backrest unit 5 so that the musical instrument stand can support the musical instrument 1 exactly. In addition, the supporting bars 3 protrudes outward from the base 2 to support the musical instrument 1 so that the musical instrument stand can support the musical instrument 1 solidly and stably. Further, the musical instrument stand can be folded easily and quickly to have a shortened volume when not in use, thereby facilitating packaging, storage and transportation of the musical instrument stand. Further, the support units 4 and the backrest unit 5 co-operate to clamp and support musical instruments of different kinds and sizes, thereby increasing the versatility of the musical instrument stand.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A musical instrument stand comprising:
a base;
two support units mounted on the base; and
a backrest unit mounted on the base; wherein:
the support units are pivotally mounted on two opposite sides of the base;
each of the support units includes a holding portion mounted a top of the base;
the backrest unit includes:
an extension arm having a first end pivotally connected with the base; and
at least one resting portion mounted on a second end of the extension arm;
the extension arm of the backrest unit is located at a rear portion of the base and is disposed between the support units; and
the backrest unit is movable relative to the base between an expanded position where the resting portion of the backrest unit is far away from the base, and a folded position where the resting portion of the backrest unit is adjacent to the base.

2. The musical instrument stand of claim 1, wherein:
the base contains a recess; and
the backrest unit and the support units are respectively arranged on a periphery of the recess of the base.

3. The musical instrument stand of claim 2, wherein:
the base is provided with a plurality of limit projections arranged in the recess; and
the support units are movable relative to the base between an opened position where the support units are far away from the limit projections of the base, and a closed position where the support units are adjacent to the limit projections of the base.

4. The musical instrument stand of claim 1, wherein:
the base has a front portion provided with a snap-fit portion;
the extension arm of the backrest unit mates with the snap-fit portion of the base in a concave-convex complimentary manner; and
the extension arm of the backrest unit is fixed and limited by the snap-fit portion of the base when the backrest unit is disposed at the folded position.

5. The musical instrument stand of claim 1, further comprising:
two supporting bars mounted on the base;
wherein each of the supporting bars is pivotally mounted on a bottom of the rear portion of the base and is extended in a direction that is far away from the base.

6. The musical instrument stand of claim 5, wherein each of the supporting bars is pivotable upward and downward relative to the base.

7. The musical instrument stand of claim 1, wherein the holding portion of each of the support units is gradually inclined downward from a front portion of the base toward the rear portion of the base.

8. The musical instrument stand of claim 7, wherein each of the support units further includes:
a front stop mounted on the base; and
a rear stop mounted on the base.

9. The musical instrument stand of claim 8, wherein:
each of the support units further includes an auxiliary stop pivotally mounted on the base; and
the auxiliary stop of each of the support units is disposed between the front stop and the rear stop.

10. The musical instrument stand of claim 1, wherein the extension arm of the backrest unit is inclined toward a direction that is far away from the base, when the backrest unit is disposed at the expanded position.
